(19) United States
(12) Patent Application Publication
(10) Pub. No.: US 2004/0243997 A1
(43) Pub. Date: Dec. 2, 2004

(54) Method, system, and program for installing program components on a computer

(75) Inventors: Anthony J. Mullen, Broomfield, CO (US); Tony L. Callahan, Westminister, CO (US)

Correspondence Address: FINNEGAN, HENDERSON, FARABOW, GARRETT & DUNNER, LLP, 1300 I STREET, NW, WASHINGTON, DC, 20005, US

(73) Assignee: Sun Microsystems, Inc.

(21) Appl. No.: 10/449,139

(22) Filed: May 29, 2003

(51) Int. Cl. G06F 9/445

(52) U.S. Cl. 717/174

(57) ABSTRACT

Provided are a method, system, and program for installing program components on a computer including a first operating system installed in a first file directory. A second file directory is created and an operating system image is copied to the second file directory to provide a second operating system installed on the computer. Configuration setting information is processed to determine configuration settings for the first operating system in the first file directory. The determined configuration settings is copied from the first file directory to configuration settings in the second file directory, wherein the second operating system uses the configuration settings copied to the second file directory.

### BACKGROUND OF THE INVENTION

1. Field of the Invention

The present invention relates to a method, system, and program for installing program components on a computer.

2. Description of the Related Art

Computer users wanting to upgrade a computer operating system typically must apply an upgrade and then reboot the operating system. Given the extent of the upgrade, this operation can take a significant amount of time or perhaps multiple reboots during which the computer is unavailable. Certain processing units may be operating in a network environment and their unavailability during an upgrade can disrupt network operations and user access to data, which is especially undesirable in a large network environment with numerous users and mission critical data. Further, in certain situations, users may want to downward revision the operating environment to a lower version. This typically requires uninstalling the current operating system and then reinstalling the lower version. A downward revision may take the operating system down for an even longer time than an upgrade due to the need to uninstall the current version and then reinstall the lower version.

Users upgrading or downgrading an operating system may also want to tailor the version change operation to remove any program components that are not needed by the processing unit subject to the version change. For instance, certain processing units may operate in a limited capacity and have a limited set of functions, such as a service processor in a storage system that is limited to performing monitoring and notification operations for the storage system. The administrator may want to remove many of the installed operating system components because such components are not needed for such a limited use processing unit. Such tailoring operations to remove operating system components to produce a desired installation can take even more time during which the processing unit is unavailable. The unavailability of a limited use processing unit may make other components and resources unavailable. For instance, taking a service processor down to change the operating system version and tailor the installation may result in the entire storage system being unavailable, which may leave numerous network users unable to access their data.

### SUMMARY OF THE DESCRIBED IMPLEMENTATIONS

Provided are a method, system, and program for installing program components on a computer including a first operating system installed in a first file directory. A second file directory is created and an operating system image is copied to the second file directory to provide a second operating system installed on the computer. Configuration setting information is processed to determine configuration settings for the first operating system in the first file directory. The determined configuration settings is copied from the first file directory to configuration settings in the second file directory, wherein the second operating system uses the configuration settings copied to the second file directory.

In further implementations, the first operating system executes in the computer unaffected while the second operating system and configuration settings are installed in the second file directory.

In still further implementations, a boot file is modified to indicate that the computer boots from the second operating system in the second file directory and the computer is rebooted from the second operating system in the second file directory following the modification to the boot file.

Still further, the computer may further include at least one preexisting application program. In such case, at least one application program image is copied to the second file directory to install the at least one application program to execute with the second operating system. The application configuration setting information is processed to determine application configuration settings included in the computer for the at least one preexisting application program and the determined application configuration settings are copied to application configuration settings in the second file directory, wherein the installed at least one application program that executes with the second operating system uses the configuration settings copied to the second file directory.

### BRIEF DESCRIPTION OF THE DRAWINGS

Referring now to the drawings in which like reference numbers represent corresponding parts throughout:

FIG. 1 illustrates a computing environment in accordance with implementations of the invention;

FIG. 2 illustrates program components in a system installation package in accordance with implementations of the invention;

FIG. 3 illustrates a data structure used to maintain configuration settings in accordance with implementations of his invention;

FIG. 4 illustrates a configuration of program components in a computer when installing an installation package in accordance with implementations of the invention;

FIG. 5 illustrates operations to install program components on the computer in accordance with implementations of the invention;

FIG. 6 illustrates operations a technician performs to install program components in accordance with implementations of the invention; and

FIG. 7 illustrates an architecture of computing devices that may be used with the described implementations.

### DETAILED DESCRIPTION

In the following description, reference is made to the accompanying drawings which form a part hereof and which illustrate several embodiments of the present invention. It is understood that other embodiments may be utilized and structural and operational changes may be made without departing from the scope of the present invention.

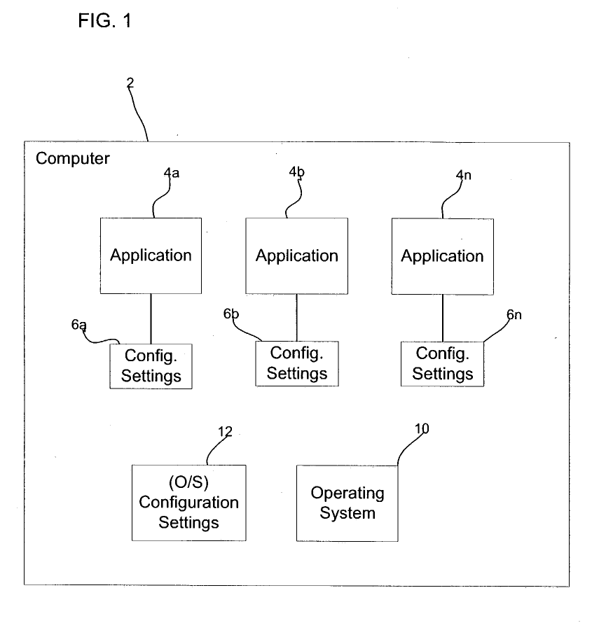

FIG. 1 illustrates a computing environment in which aspects of the invention are implemented. A computer 2 includes a plurality of installed application programs 4a, 4b . . . 4n each having associated configuration settings 6a, 6b . . . 6n providing configuration parameters used by the application 4a, 4b . . . 4n to configure the application 4a, 4b . . . 4n operation. The computer 2 further includes an operating system 10 and operating system configuration settings 12. The operating system 10 may comprise any operating system known in the art. The computer 2 may include any computing device known in the art, such as a desktop computer, workstation, laptop, server, mainframe, hand held computer, telephony device, network appliance, storage subsystem, etc. In certain described implementations, the computer 2 may comprise a service processor that is included in a mass storage system, such as a Redundant Array of Independent Disks (RAID), Just a Bunch of Disks (JBOD), etc. A service processor may include application programs to perform operations such as system monitoring and maintenance for the storage system in which the processor is embedded, as well as interfacing with remote administrators requesting system information and performing system configuration operations.

The application programs 4a, 4b . . . 4n may comprise any application program known in the art. The configuration settings 6a, 6b . . . 6n for each application program 4a, 4b . . . 4n may be maintained in one or more data structures in the computer 2. For instance, in a Microsoft® Windows® operating system environment, the configuration settings 6a, 6b . . . 6n may be maintained in the registry file, initialization files (.ini), etc. In a Unix® operating system environment, the configuration settings 6a, 6b . . . 6n may be maintained in a binary file (.bin), text file (.txt), etc. (Microsoft and Windows are registered trademarks of Microsoft Corporation and Unix is a registered trademark of The Open Group) Moreover, the configuration settings 6a, 6b . . . 6n for one application 4a, 4b . . . 4n may be maintained in multiple data structures.

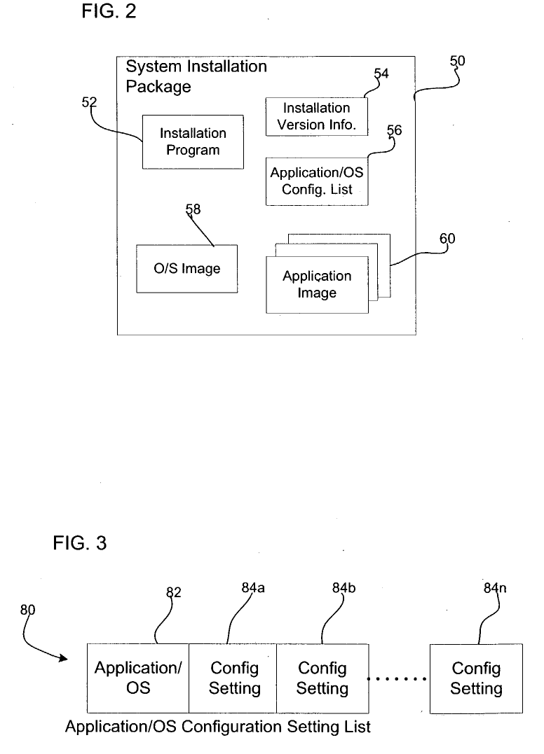

Described implementations provide a system installation package that includes various components of code to install a particular version of programs on the computer 2. FIG. 2 illustrates the system installation package 50 as including an installation program 52, installation version information 54, an operating system image 58, and one or more application program images 60. The installation program 52 comprises the code that performs the installation operations to install the operating system version indicated in the installation version information 54 on the computer 2. The application/operating system (OS) configuration list 56 provides information on the configuration settings to be copied from the current installed operating system 10 on the computer to the file directory used by the operating system and applications being installed by the system installation package 50. The operating system (OS) installation image 58 may comprise an image of all the installed operating system components, such as files, configuration files, and drivers. The application image(s) 60 may comprise an image of the installed application programs, including configuration files.

The system installation package 50 may be implemented on a removable storage medium, such as a CD-ROM, flash memory, external hard disk drive, disk, etc. Alternatively, the system installation package 50 may comprise one or more files downloaded from a remote site to execute on the computer 2 to install the operating system 58 and application files 60 on the computer 2.

FIG. 3 illustrates information maintained in the application/OS configuration list 56. The application/OS configuration list 56 may include entries 80, where each entry identifies an operating system or application program 82 included in the installation and one or more configuration settings 84a, 84b . . . 84n that are to be copied from the configuration settings of the currently installed operating system or application to the configuration settings used by the operating system and applications installed from the system installation package 50. The configuration setting 84a, 84b . . . 84n information would indicate a location relative to the root location of the currently installed operating system where the configuration setting to copy and the target location of where to write the copied configuration setting are located relative to the root of the operating system or application installed from the system installation package 50. As discussed, the copied configuration setting may comprise a file or a parameter or value accessed from a file. The configuration setting information may be implemented in different data formats and data structures than shown in FIG. 3.

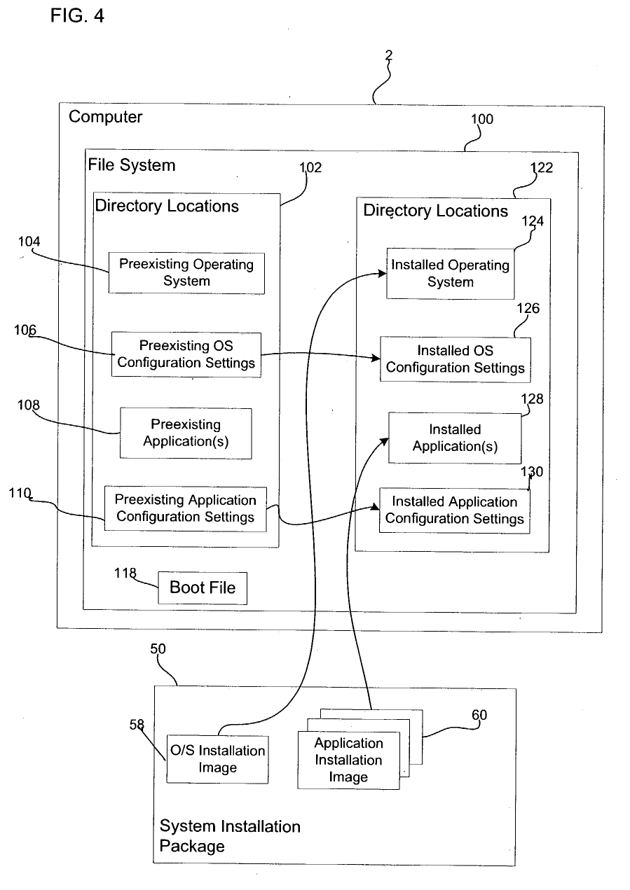

FIG. 4 illustrates the computer 2 as including a file system 100, which may be a hierarchical file system known in the art, having directory locations 102 that store a pre-existing operating system 104, preexisting operating system configuration settings, one or more preexisting applications 106 and preexisting application program settings 108 that comprise the program components installed on the computer 2 before application of the operating system installation package 50. The installation program 52 in the system installation package 50 would install the operating system 110 and application(s) 112 from the operating system image 58 and the application image(s) 60 in the system installation package 50 into directory location 122. The installation program 52 would copy operating system configuration settings from the preexisting OS configuration settings 106 and the preexisting application configuration settings 110 to the installed OS configuration settings 126 and installed application configuration settings 130, so that the configuration settings used in the preexisting configuration are carried over to the components being installed by the system installation package 50.

The directory locations 122 for the new installation may be on the same logical disk or on a different logical disk or partition than the directory locations 102 of the preexisting installation. Further, the directory locations 102, 122 may include multiple file directories to store the operating systems 104, 124 and applications 108, 128. In such case, the directory locations 102 and 122 may include directories to store the installed components that hierarchically extend from different root directories or logical drives, i.e., are descendants of different directories or logical drives.

In certain implementations, the operating system 58 and application 60 components may be contained within a single image including all the installable components of the system installation package 50 or multiple images.

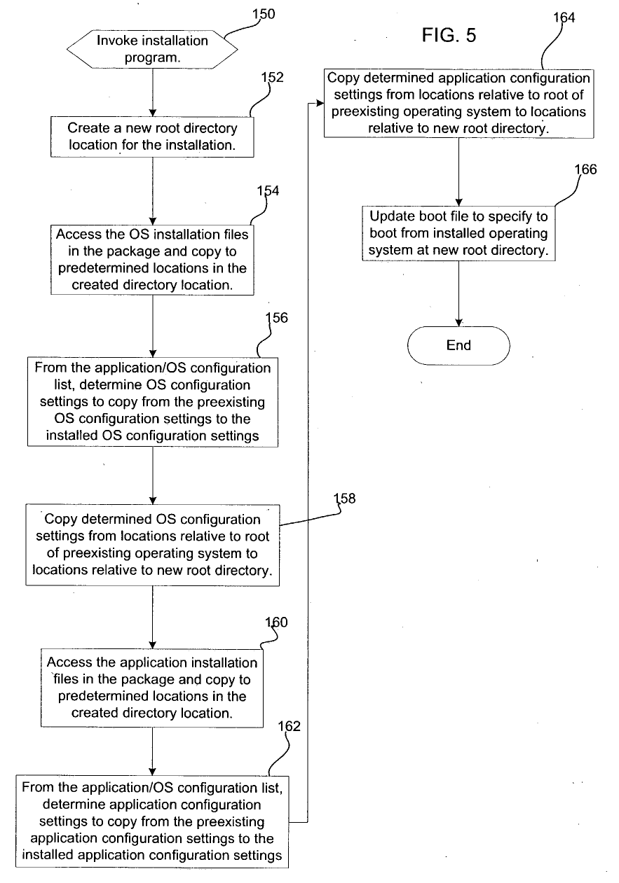

FIG. 5 illustrates logic implemented in the installation program 52 to install the components in the system installation package 50. Upon being invoked (at block 150), the installation program 52 creates (at block 152) a new root directory for the new installation in the file system 100. In certain implementations, the directory locations 122 will allow the installation of the components 58 and 60 of the system installation package 50 without interfering with the preexisting installed operating system 104 and applications 108 in directory locations 102. During the installation, the preexisting operating system and applications may continue to run and perform operations while the new components 58 and 60 (FIG. 4) are being installed. Later, when the computer 2 is rebooted, the boot file would cause the computer 2 to run the new installed operating system and application from the installed operating system 124 and application 128 images.

The installation program 52 accesses (at block 154) the operating system image 58 in the package 50 and copies the accessed image 58 to predetermined locations in the created directory location 122. The installation program 52 then processes (at block 156) the application/OS configuration list 56 to determine the operating system configuration settings 6a, 6b . . . 6c to copy from the preexisting operating system configuration settings 106 to the installed operating system configuration settings 126. The configuration settings to copy may be determined configuration settings 84a, 84b . . . 84n indicated in the entry 80 (FIG. 3) for the operating system in the configuration list 56. The determined preexisting operating system configuration settings 106 are copied (at block 158) from the directory locations 102 for the preexisting operating system 104 to locations relative to the new directory locations 122 where such configuration settings are maintained. The installation program 52 further accesses the one or more application images 60 in the package 50 and copies the accessed application image(s) 60 to locations in the created directory location 122 to provide the installed application(s) 128. The installation program 52 then processes (at block 162) the application/OS configuration list 56 to determine the application system configuration settings 6a, 6b . . . 6c to copy from the preexisting operating system configuration settings 106 to the installed OS configuration settings 126. The configuration settings to copy may be predetermined configuration settings 84a, 84b . . . 84n indicated in the entries 80 (FIG. 3) for the applications identified in the configuration list 56, where one entry 80 and set of configuration settings 84a, 84b . . . 84n may be provided for each application to install. The determined preexisting application configuration settings 110 are copied (at block 164) from the directory locations 102 for the preexisting applications 108 to locations relative to the new root directory where such application configuration settings are maintained. The installation program 52 then updates (at block 166) the boot file 118 to indicate that the system should boot from the operating system installed in the new directory locations 114, so that the next time the computer 2 reboots, the computer 2 will run the operating system and application from the newly installed operating system 110 and application 112 images. In this way, the installation of the new version or down version will not affect or interrupt the current operations of the computer 2 running from the preexisting operating system 104 and application(s) 108.

In certain implementations, the configuration setting entry 80 (FIG. 3) may indicate a directory location and file or parameter name for the operating system or application program configurations settings 84a, 84b . . . 84n for the preexisting installation to copy and the target directory location of where to write the copied preexisting configuration settings 106, 110. The configuration settings 84a, 84b . . . 84n may indicate the source of the configuration settings to copy as relative to the root of the preexisting directory locations 102 and the target location to write the configuration settings as relative to the root of the directory locations 122 for the new installation. Alternatively, the configuration settings 84a, 84b . . . 84n may indicate the source and target locations for the configuration settings to copy as absolute file directory locations. If the configuration settings to copy are maintained in a file, then the file would be copied over. If the configuration settings to copy comprise parameters in a data structure, such as a registry file or other file, then the installation program 52 would open that data structure to access the configuration settings to copy, and then open the corresponding data structure in the new installation to update with the copied configuration setting value.

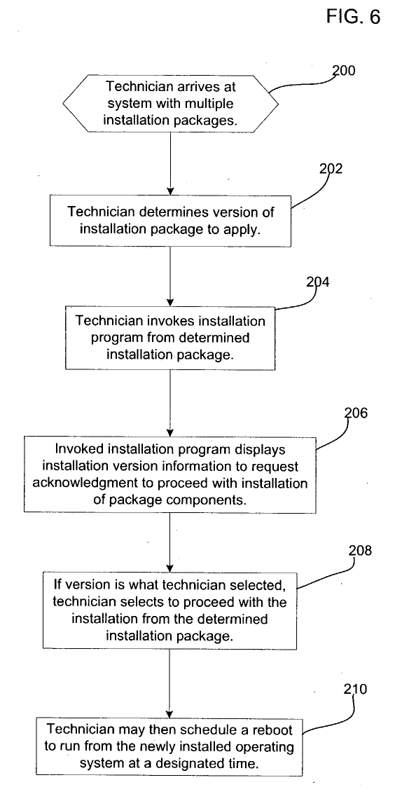

In certain implementations, a service technician may maintain multiple system installation packages 50 for different versions of the operating system and applications to install. The service technician can then easily apply any version of the operating system and applications, which may comprise an upgrade or down version from the preexisting installed operating system and application by running the installation program with the system installation package having the version the technician wants to install. FIG. 6 illustrates operations a service technician performs to apply a desired version of the operating system and applications. The upgrade begins with the technician arriving (at block 200) at the service site with multiple installation packages. The installation packages may be maintained on separate sets of removable medium, such as separate CD-ROMs. Alternatively, the service technician may use the computer 2 to access a network location from which the installation packages can be downloaded to apply to the computer 2. The technician diagnosis the situation and determines (at block 202) the version of the installation package 50 to apply. For instance, the technician may decide to apply the newest version of the operating system and applications. Alternatively, if the computer 2 is having problems with a recently installed new version, then the technician may decide to downward revision by applying a previously installed lower version of the operating system and applications that comprised the last known good configuration. The technician then invokes (at block 204) the installation program 52 from the determined installation package 50. If the installation package 50 comprises a removable storage medium, e.g., CD-ROM, removable hard disk, etc., then the technician would have to couple such removable storage medium to the computer being serviced. Alternatively, the technician may use the computer to download and execute the installation package from a remote computer over a network. The invoked installation program then displays (at block 206) installation version information 54 (FIG. 2) to request acknowledgment to proceed with installation of package components. If (at block 208) the version is what the technician intended, then the technician selects to proceed with the installation from the determined installation package. After the operating system 58 and application 60 images in the system installation package 50 are installed, the technician may then schedule a reboot operation to occur at a time of low usage for the computer 2, so that the switch-over to the newly installed operating system and applications occurs with minimal interruption to the computer operations.

The described techniques for installing a version of an operating system and/or application programs may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which described embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration without departing from the scope of the present invention, and that the article of manufacture may comprise any information bearing medium known in the art.

In described implementations, information is described as being maintained in a particular format within various data structures, such as those shown in FIGS. 2 and 3. In alternative implementations, the information described may be stored in data structures having a different arrangement, and more or less data, than the data structures described with respect to with respect to FIGS. 2 and 3.

In the described implementations, the system installation package included an operating system image and application program images. In alternative implementations, the package may include only an operating system image.

The illustrated logic of FIGS. 5 and 6 shows certain events occurring in a certain order. In alternative implementations, certain of the described operations may be performed in a different order, modified or removed. Morever, steps may be added to the above described logic and still conform to the described implementations. Further, operations described herein may occur sequentially or certain operations may be processed in parallel. Yet further, operations may be performed by a single processing unit or by distributed processing units.

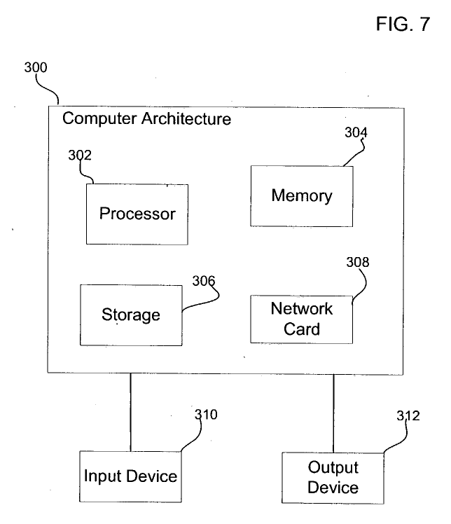

FIG. 7 illustrates one implementation of a computer architecture 300 of the system shown in FIG. 1. The architecture 300 may include a processor 302 (e.g., a microprocessor), a memory 304 (e.g., a volatile memory device), and storage 306 (e.g., a non-volatile storage, such as magnetic disk drives, optical disk drives, a tape drive, etc.). The storage 306 may comprise an internal storage device or an attached or network accessible storage. Programs in the storage 306 are loaded into the memory 304 and executed by the processor 302 in a manner known in the art. The architecture further includes a network card 308 to enable communication with a network. An input device 310 is used to provide user input to the processor 302, and may include a keyboard, mouse, pen-stylus, microphone, touch sensitive display screen, or any other activation or input mechanism known in the art. An output device 312 is capable of rendering information transmitted from the processor 302, or other component, such as a display monitor, printer, storage, etc.

The foregoing description of various implementations of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for installing program components on a computer including a first operating system installed in a first file directory, comprising:
creating a second file directory;
copying an operating system image to the second file directory to provide a second operating system installed on the computer;
processing configuration setting information to determine configuration settings for the first operating system in the first file directory; and
copying the determined configuration settings from the first file directory to configuration settings in the second file directory, wherein the second operating system uses the configuration settings copied to the second file directory.

2. The method of claim 1, wherein the first operating system executes in the computer, and wherein the installation of the second operating system and configuration settings in the second file directory does not interfere with the operation of the first operations system.

3. The method of claim 2, further comprising:
modifying a boot file to indicate that the computer boots from the second operating system in the second file directory; and
rebooting the computer from the second operating system in the second file directory following the modification to the boot file.

4. The method of claim 1, wherein the operating system image and configuration setting information are embedded in a removable storage medium coupled to the computer.

5. The method of claim 1, wherein the operating system image and configuration setting information are downloaded from a remote computer over a network to the computer.

6. The method of claim 1, wherein the computer further includes at least one preexisting application program, further comprising:
copying at least one application program image to the second file directory to install the at least one application program to execute with the second operating system;
processing application configuration setting information to determine application configuration settings included in the computer for the at least one preexisting application program; and
copying the determined application configuration settings to application configuration settings in the second file directory, wherein the installed at least one application program that executes with the second operating system uses the configuration settings copied to the second file directory.

7. The method of claim 1, wherein the configuration setting information indicates a location of configuration settings in the first file directory to copy to configuration settings in the second file directory accessible to the second operating system.

8. The method of claim 7, wherein the location of the configuration settings indicates: (i) a location of at least one file in the first file directory to copy to the second file directory and/or (ii) at least one value to copy from at least one data structure included in the first file directory, wherein the at least one value is written to at least one data structure included in the second file directory.

9. The method of claim 1, wherein there are multiple installation sets of an operating system image and configuration setting information, wherein each installation set includes a different version of the operating system included in the operating system image.

10. The method of claim 9, further comprising:
determining one installation set for a specific version of the operating system; and
processing one installation set to install the operating system image of the specific version.

11. The method of claim 10, wherein the specific version of the second operating system to install is a down version or upgrade with respect to a version of the first operating system installed on the computer.

12. The method of claim 10, wherein the operating system image included in the determined installation set is installed while the computer is running the first operating system, and wherein the computer boots from the second operating system when a power cycle event is scheduled.

13. A system for installing program components, comprising:
a processor;
a first file directory and a second file directory;
a first operating system installed in a first file directory;
a computer readable medium accessible to the processor;
an operating system image and configuration setting information in the computer readable medium; and
an installation program in the computer readable medium that when executed by the processor causes the processor to perform:
(i) creating a second file directory;
(ii) copying the operating system image to the second file directory to provide a second operating system installed on the computer;
(iii) processing the configuration setting information to determine configuration settings for the first operating system in the first file directory; and
(iv) copying the determined configuration settings from the first file directory to configuration settings in the second file directory, wherein the second operating system uses the configuration settings copied to the second file directory.

14. The system of claim 13, wherein the first operating system executes in the computer, and wherein the installation of the second operating system and configuration settings in the second file directory does not interfere with the operation of the first operations system.

15. The system of claim 13, wherein execution of the installation program further causes the processor to perform:
modifying a boot file to indicate that the computer boots from the second operating system in the second file directory; and
rebooting the computer from the second operating system in the second file directory following the modification to the boot file.

16. The system of claim 13:
at least one preexisting application program in the computer readable medium,
at least one application program image and application configuration setting information in the computer readable medium, wherein execution of the installation program further causes the processor to perform:
(i) copying the at least one application program image to the second file directory to install the at least one application program to execute with the second operating system;
(ii) processing the application configuration setting information to determine application configuration settings included in the computer for the at least one preexisting application program; and
(iv) copying the determined application configuration settings to application configuration settings in the second file directory, wherein the installed at least one application program that executes with the second operating system uses the configuration settings copied to the second file directory.

17. The system of claim 13, wherein the provided configuration setting information indicates a location of configuration settings in the first file directory to copy to configuration settings in the second file directory accessible to the second operating system.

18. The system of claim 13, wherein the computer readable medium further includes:
multiple installation sets of an operating system image, an installation program, and configuration setting information, wherein each installation set includes a different version of the operating system included in the operating system image.

19. The system of claim 18, wherein executing the installation program further causes the processor to perform:
determining one installation set for a specific version of the operating system; and
executing the installation program included in the determined installation set to install the operating system image of the specific version.

20. An article of manufacture for installing program components on a computer including a first operating system installed in a first file directory, wherein the article of manufacture comprises:
an operating system image, an installation program, and configuration setting information, wherein the installation program is executed to cause the computer to perform:
(i) creating a second file directory;
(ii) copying the operating system image to the second file directory to provide a second operating system installed on the computer;
(iii) processing the configuration setting information to determine configuration settings for the first operating system in the first file directory; and
(iv) copying the determined configuration settings from the first file directory to configuration settings in the second file directory, wherein the second operating system uses the configuration settings copied to the second file directory.

21. The article of manufacture of claim 20, wherein the first operating system executes in the computer, wherein the installation of the second operating system and configuration settings in the second file directory does not interfere with the operation of the first operations system.

22. The article of manufacture of claim 21, wherein the installation program is executed to further cause the computer to perform:
modifying a boot file to indicate that the computer boots from the second operating system in the second file directory; and
rebooting the computer from the second operating system in the second file directory following the modification to the boot file.

23. The article of manufacture of claim 20, wherein the operating system image, installation program, and configuration setting information are embedded in a removable storage medium coupled to the computer.

24. The article of manufacture of claim 20, wherein the operating system image, installation program, and configuration setting information are downloaded from a remote computer over a network to the computer.

25. The article of manufacture of claim 20, wherein the computer further includes at least one preexisting application program, further comprising:
at least one application program image and application configuration setting information, wherein the installation program is executed to further cause the computer to perform:
(i) copying the at least one application program image to the second file directory to install the at least one application program to execute with the second operating system;
(ii) processing the application configuration setting information to determine application configuration settings included in the computer for the at least one preexisting application program; and
(iv) copying the determined application configuration settings to application configuration settings in the second file directory, wherein the installed at least one application program that executes with the second operating system uses the configuration settings copied to the second file directory.

26. The article of manufacture of claim 20, wherein the configuration setting information indicates a location of configuration settings in the first file directory to copy to configuration settings in the second file directory accessible to the second operating system.

27. The article of manufacture of claim 26, wherein the location of the configuration settings indicates: (i) a location of at least one file in the first file directory to copy to the second file directory and/or (ii) at least one value to copy from at least one data structure included in the first file directory, wherein the at least one value is written to at least one data structure included in the second file directory.

28. The article of manufacture of claim 20, wherein the article of manufacture further comprises:
multiple installation sets of an operating system image, an installation program, and configuration setting information, wherein each installation set includes a different version of the operating system included in the operating System image.

29. The article of manufacture of claim 28, wherein the installation program is executed to further cause the computer to perform:
determining one installation set for a specific version of the operating system; and
executing the installation program included in the determined installation set to install the operating system image of the specific version.

30. The article of manufacture of claim 29, wherein the specific version of the second operating system to install is a down version or upgrade with respect to a version of the first operating system installed on the computer.

31. The article of manufacture of claim 29, wherein the executed installation program installs the operating system image included in the determined installation set while the computer is running the first operating system, and wherein the computer boots from the second operating system when a power cycle event is scheduled.
